(19) United States
(12) Patent Application Publication
(10) Pub. No.: US 2017/0305365 A1
(43) Pub. Date: Oct. 26, 2017

(54) DRIVING INFORMATION DISPLAY APPARATUS AND DRIVING INFORMATION DISPLAY METHOD

(71) Applicant: DENSO CORPORATION, Kariya-city, Aichi-pref. (JP)

(72) Inventor: Arihiro MATSUMOTO, Kariya-city (JP)

(21) Appl. No.: 15/517,677

(22) PCT Filed: Oct. 13, 2015
(86) PCT No.: PCT/JP2015/005171

§ 371 Date: Apr. 7, 2017

(30) Foreign Application Priority Data
Oct. 29, 2014 (JP) 2014-220703

(51) Int. Cl. B60R 16/02; B60K 37/06; G08G 1/16

(52) U.S. Cl. CPC B60R 16/02; G08G 1/16; B60K 37/06; B60K 2350/901; B60K 2350/352; B60K 2350/1068; B60K 2350/908; B60R 2300/8046; B60K 2350/903

(57) ABSTRACT

A driving information display apparatus acquires driving information that is to be displayed to a driver of a vehicle along with driving of the vehicle, and outputs the acquired driving information to a display. Further, extra information to be displayed in addition to the driving information, and risk level information about a level of risk involved in the driving of the vehicle are acquired. When outputting the extra information to the display, a display time of displaying the extra information is set based on the risk level information and outputting of the extra information is controlled based on the set display time.

### CROSS REFERENCE TO RELATED APPLICATION

The present application is based on Japanese Patent Application No. 2014-220703 filed on Oct. 29, 2014, the disclosure of which is incorporated herein by reference.

### TECHNICAL FIELD

The present disclosure applies to a vehicle having a display that is positioned to be viewable by a driver of the vehicle, and relates to a driving information display apparatus or driving information display method for displaying, on the display, driving information to be presented to the driver along with the driving of the vehicle.

### BACKGROUND ART

When driving a vehicle, a driver of the vehicle needs to confirm various information; thus, various displays are mounted in the vehicle to enable the driver to confirm such information (driving information) with ease. For example, a combination meter is mounted behind a steering wheel as viewed from a driver's seat in order to display various driving information such as a vehicle speed, a shift position of a transmission, and the amount of remaining fuel. Further, a display screen of a navigation system is mounted at the center of a dashboard to display various driving information. Meanwhile, there are similarly developed a technology for implementing the functions of various meters through the use of images by incorporating a vehicle-mounted liquid crystal display instead of the combination meter and another technology of a head-up display for displaying a virtual image by projecting images onto a windshield or other transparent plate member in front of the driver's seat.

Further, a technology called “electronic side view mirror” is recently proposed (Patent Literature 1). This technology eliminates the necessity of a side view mirror by capturing an image presenting a lateral rear view from the vehicle with an on-vehicle camera mounted instead of a side view mirror and displaying the captured image on a display screen, for example, of a liquid crystal display mounted in a vehicle compartment.

In order to assist the driver in driving the vehicle, the above-mentioned displays may display extra information in addition to primary driving information. When the display screen in the vehicle compartment shows a following vehicle that is traveling in the lateral rear of the vehicle, the electronic side view mirror may draw a driver's attention by displaying extra information, such as a highlighted outline around the following vehicle and the distance to the following vehicle.

### PRIOR ART LITERATURES

### Patent Literature

Patent Literature 1: JP 2014-118020 A

### SUMMARY OF INVENTION

Although the extra information is displayed to assist the driver in driving the vehicle, displaying the extra information may unexpectedly interfere with the driving. The reason is that the extra information is not usually displayed, and that displayed extra information excessively draws the driver's attention. This may divert the driver's attention away from the surroundings of the vehicle.

It is an object of the present disclosure to provide a technology for displaying extra information on a display without obstructing a driving operation of a driver of a vehicle.

To achieve the above object, according to an example of the present disclosure, a driving information display apparatus and a driving information display method each are provided as acquiring driving information that is to be displayed to a driver of a vehicle along with driving of the vehicle, and outputting the acquired driving information to a display. Further, extra information to be displayed in addition to the driving information, and risk level information about a level of risk involved in the driving of the vehicle are acquired. When outputting the extra information to the display, a display time of displaying the extra information is set based on the risk level information, and outputting of the extra information is controlled based on the set display time.

The above configuration allows the extra information, even if appearing on the display, to disappear with a lapse of a display time set based on the risk level information. Thus, the driver's attention can be directed to the confirmation of the surroundings of the vehicle without excessively drawing the driver's attention to the extra information.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating a vehicle mounting with a driving information display apparatus according to an embodiment of the present disclosure;

FIG. 2 is a diagram illustrating how to display driving information and extra information on an electronic side view mirror;

FIG. 3 is a diagram illustrating a schematic internal structure of the driving information display apparatus;

FIG. 4 is a flowchart illustrating a first half of a driving information display process performed by the driving information display apparatus;

FIG. 5 is a flowchart illustrating a second half of the driving information display process;

FIG. 6 is a diagram illustrating an extra information management table that is referenced by the driving information display apparatus during the driving information display process;

FIG. 7 is a diagram illustrating a display history management table that is referenced by the driving information display apparatus during the driving information display process;

FIG. 8 is a diagram illustrating a method of determining an extra information display time during which the driving information display apparatus displays the extra information;

FIG. 9 is a diagram illustrating how the driving information display apparatus manages the extra information display time;

FIG. 10 is a diagram illustrating the extra information displayed on a navigation display screen;

FIG. 11 is a diagram illustrating how to display the extra information on a screen showing a captured forward-view image;

FIG. 12 is a diagram illustrating how to display the extra information in a display installed behind a steering wheel; and

FIG. 13 is a diagram illustrating how to display the extra information in a head-up display apparatus.

### EMBODIMENTS FOR CARRYING OUT INVENTION

An embodiment of the present disclosure is described below.

A. Apparatus Configuration

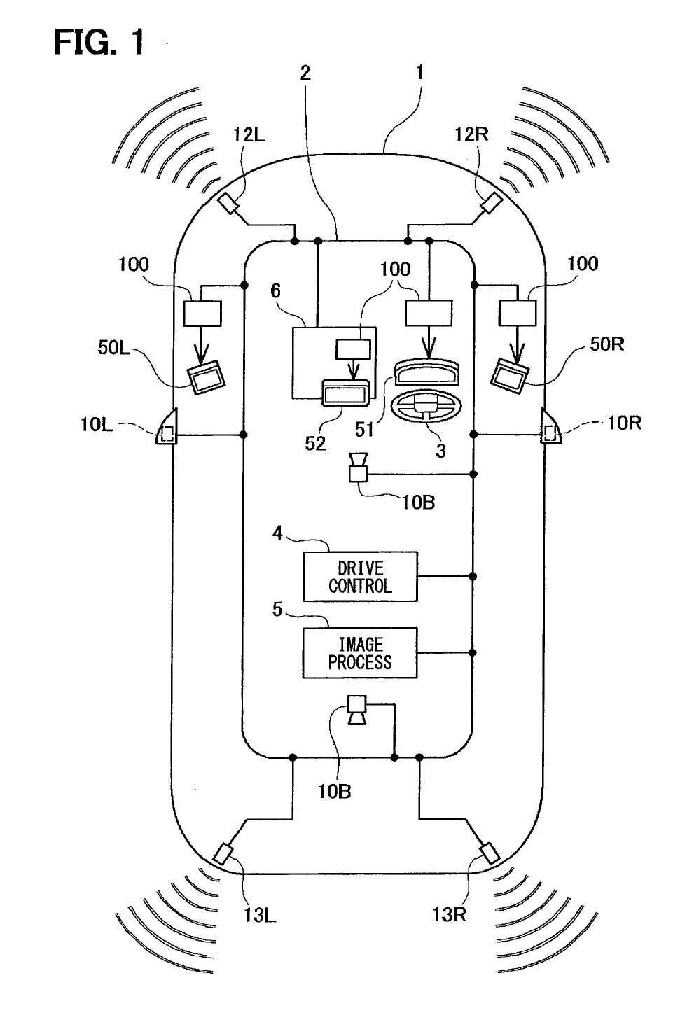

FIG. 1 illustrates a vehicle 1 in which a driving information display apparatus 100 is mounted. The vehicle 1 may be referred to as a host vehicle. The word “information” is used not only as an uncountable noun but also as a countable noun. Further, the word “information” may be abbreviated to “info.” Various instruments are mounted in the vehicle 1 around a drive control apparatus 4. The drive control apparatus 4 provides control over the driving of the vehicle 1. The various instruments are capable of communicating data to each other through an in-vehicle network 2. For example, a front camera 10F and a rear camera 10B are mounted in a vehicle compartment of the vehicle 1 and connected to the in-vehicle network 2. The front camera 10F captures an image showing a front situation of a front region relative to the vehicle 1. The rear camera 10B captures an image showing a rear situation of a rear region relative to the vehicle 1. The in-vehicle network 2 is also connected to an image processing apparatus 5. The image processing apparatus 5 acquires images captured by the front camera 10F and the rear camera 10B through the in-vehicle network 2. The image processing apparatus 5 then performs predetermined image processing in order to detect pedestrians, different vehicles, and obstacles, and outputs the result of image processing to the in-vehicle network 2.

A left lateral camera 10L is mounted on a left side face of the vehicle 1 to capture an image showing a left-rear situation of a left-rear region relative to the vehicle 1. A right lateral camera 10R is mounted on a right side face of the vehicle 1 to capture an image showing a right-rear situation of a right-rear region relative to the vehicle 1. Both the left lateral camera 10L and the right lateral camera 10R outputs captured image data to the in-vehicle network 2. The image processing apparatus 5 then acquires the image data through the in-vehicle network 2 and performs predetermined image processing in order to detect pedestrians and different vehicles. Further, a navigation system 6 and sonars 12L, 12R, 13L, 13R are also mounted in the vehicle 1 and connected to the in-vehicle network 2. The sonars 12L, 12R detect obstacles in front of the vehicle 1. The sonars 13L, 13R detect obstacles behind the vehicle 1.

A plurality of displays are mounted in the vehicle compartment of the vehicle 1 to display information for driving (driving information) to a driver of the vehicle. A display 51 for displaying driving information, such as a vehicle speed, an engine rotation speed, a transmission shift position, and a remaining fuel amount, is mounted behind a steering wheel 3. A display 52 for displaying driving information from the navigation system 6, such as route information and map information, is mounted at the center of a dashboard. Additionally, displays 50L, 50R are mounted on the left and right sides in the vehicle compartment. In the embodiment, the displays 50L, 50R, 51, 52 are formed of a liquid-crystal screen. However, the displays 50L, 50R, 51, 52 need not always be formed of a liquid-crystal screen. Any other screens may be used as far as they are capable of displaying the driving information to the driver of the vehicle. The displays may be formed by combining mechanical meters with lamps or LEDs that illuminate as needed.

The displays 50L, 50R, 51, 52 are connected to the in-vehicle network 2 through the driving information display apparatus 100. The driving information display apparatus 100 acquires driving information associated with the displays 50L, 50R, 51, 52 from various information flowing in the in-vehicle network 2, and outputs the acquired driving information to the displays 50L, 50R, 51, 52. The driving information display apparatus 100 connected to the display 50R on the right side in the vehicle compartment implements a so-called electronic side view mirror by acquiring image data captured by the right lateral camera 10R and displaying the captured image data on the display 50R. Similarly, the driving information display apparatus 100 connected to the display 50L on the left side in the vehicle compartment implements an electronic side view mirror by acquiring image data captured by the left lateral camera 10L and displaying the captured image data on the display 50L.

The driving information display apparatus 100 connected to the display 51 behind the steering wheel 3 acquires driving information outputted from the drive control apparatus 4, such as the vehicle speed, the engine rotation speed, and the transmission shift position, through the in-vehicle network 2 and outputs the acquired driving information to the display 51. Further, the navigation system 6 incorporates the driving information display apparatus 100 according to the embodiment. Driving information outputted from the navigation system 6, such as the route information and the map information, is displayed on the display 52 through the driving information display apparatus 100.

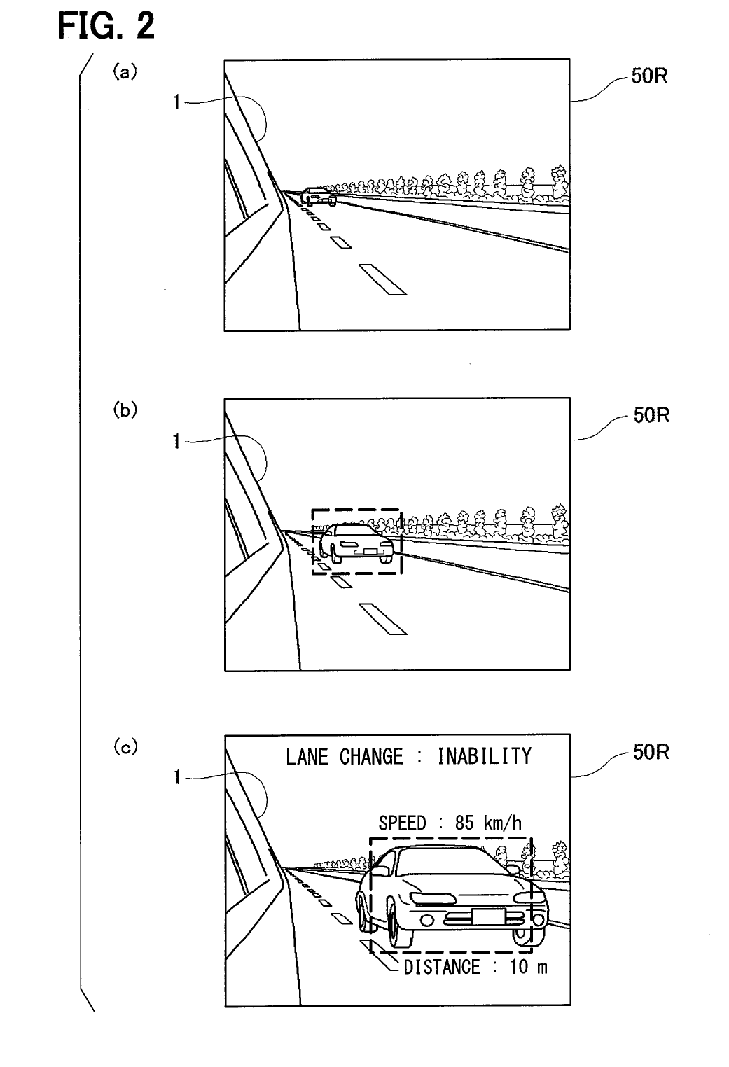

The displays 50L, 50R, 51, 52 may display extra information in addition to primary driving information. As an example, the display 50R mounted on the right side in the vehicle compartment will now be described. FIG. 2 illustrates how the screen of the display 50R mounted on the right side in the vehicle compartment displays the extra information in addition to the driving information. At (a) in FIG. 2, the display 50R implements a so-called electronic side view mirror by displaying an image captured by the right lateral camera 10R. Here, the image captured by the right lateral camera 10R corresponds to the driving information. The displayed image shows a distant following vehicle that follows the vehicle 1 from behind. However, as the displayed image of the following vehicle is small, the image processing apparatus 5 does not detect the following vehicle, and the screen of the display 50R does not particularly draw a driver's attention.

As the following vehicle approaches the vehicle 1, the image of the following vehicle occupies a significant portion of the image captured by the right lateral camera 10R. Therefore, at (b) in FIG. 2, the screen of the display 50R shows a large image of the following vehicle and a highlighted outline enclosing the following vehicle in order to draw the driver's attention. The highlighted outline is displayed based on the result that is obtained when the image processing apparatus 5 detects the following vehicle through the analysis of the image captured by the right lateral camera 10R and outputted to the in-vehicle network 2. At (b) in FIG. 2, the highlighted outline is indicated by a broken-line rectangle. The highlighted outline is the extra information, which is displayed in addition to the image displayed as the driving information.

Eventually, when the following vehicle further approaches the vehicle 1, additional extra information is displayed in addition to the highlighted outline enclosing the following vehicle at (c) in FIG. 2. The displayed additional extra information may include the distance to the following vehicle, the traveling speed of the following vehicle, and a message instructing the driver not to change lanes. The additional extra information is detected by the image processing apparatus 5 through the analysis of captured images or detected by various instruments (e.g., a vehicle-to-vehicle communication instrument) connected to the in-vehicle network 2, and then outputted to the in-vehicle network 2.

When the display 50R displays various extra information as described in addition to an image captured by the right lateral camera 10R, the driver is able to accurately grasp the surroundings of the vehicle 1. The above-described extra information is not displayed under normal conditions at (a) in FIG. 2, but is additionally displayed at (b) or (c) in FIG. 2. Such displayed extra information may excessively draw the driver's attention, possibly diverting the driver's attention away from the surroundings.

The above situation may also be caused by displays 51, 52 other than the display 50R. The display 51 behind the steering wheel 3 displays the remaining fuel amount as the driving information. When the remaining fuel amount is small, the display 51 may display the predicted distance to empty as the extra information. However, when the display 51 displays the predicted distance to empty, the driver attempts to read it so that the driver's attention may be diverted away from the surroundings.

In order to display the extra information to the driver without causing the above difficulty, the driving information display apparatus 100 according to the embodiment has the following internal structure.

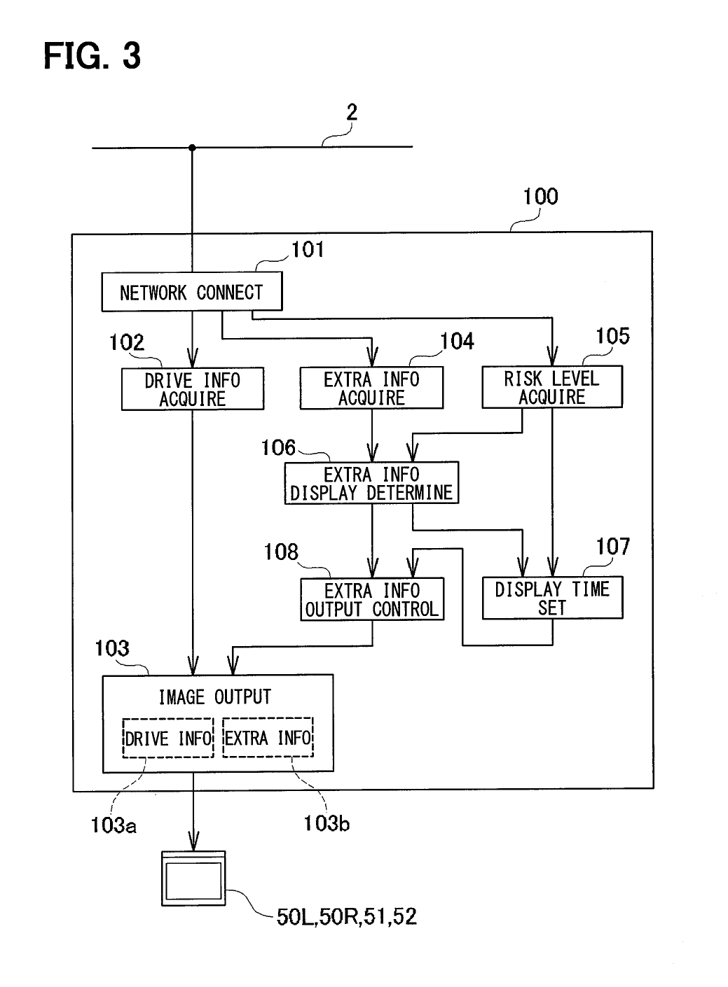

FIG. 3 illustrates a schematic internal structure of the driving information display apparatus 100. As illustrated, the driving information display apparatus 100 includes a network connection section 101, a driving information acquisition section 102, an image output section 103, an extra information acquisition section 104, a risk level acquisition section 105, an extra information display determination section 106, a display time setting section 107, and an extra information output control section 108. The driving information display apparatus 100 includes an electronic control unit. In the embodiment, the electronic control unit is implemented by a microcomputer that is formed of a CPU as a central part, memories including a ROM and a RAM, a timer, and an I/O peripheral, which are interconnected through a bus so as to establish data communication. Thus, each of the above eight “sections” may be referred to as a device or a module. These sections do not imply that the driving information display apparatus 100 is physically divided into eight sections, and are obtained when the internal structure of the driving information display apparatus 100 is classified for descriptive purposes according to the functionality exercised by the driving information display apparatus 100 to let the displays 50L, 50R, 51, 52 display the driving information and the extra information. Therefore, these “sections” can be implemented either as a computer program executable by the CPU of the microcomputer through the use of separate hardware, or, alternatively, as hardware such as an electronic circuit including an LSI and a memory; further, they can be implemented by a combination of the foregoing. The program can be stored in the above memory or a different memory as a non-transitory computer-readable storage medium.

The network connection section 101 acquires, from various information flowing in the in-vehicle network 2, information associated with the display connected to the driving information display apparatus 100. For convenience of understanding, the following assumes that, based on the example of FIG. 2, the display is the display 50R for displaying the situation on the right lateral region relative to the vehicle 1, and that the driving information display apparatus 100 is the driving information display apparatus 100 connected to the display 50R. In this case, the network connection section 101 selectively acquires, from various information flowing in the in-vehicle network 2, the information to be displayed on the display 50R.

The driving information acquisition section 102 acquires the driving information (i.e., an image captured by the right lateral camera 10R) from various information that is obtained by the network connection section 101 through the in-vehicle network 2, and supplies the acquired driving information to the image output section 103. Based on the driving information supplied from the driving information acquisition section 102, the image output section 103 generates an image to be actually displayed on the screen of the display 50R, and outputs the generated image to the display 50R.

The extra information acquisition section 104 acquires the extra information from information that is obtained by the network connection section 101 through the in-vehicle network 2. If the image processing apparatus 5 has detected the following vehicle by analyzing an image captured by the right lateral camera 10R and has outputted the result of detection to the in-vehicle network 2, the extra information acquisition section 104 acquires the result of detection of the following vehicle. Further, if the extra information such as the distance to the following vehicle and the vehicle speed of the following vehicle is flowing in the in-vehicle network 2, the extra information acquisition section 104 acquires such extra information as well.

When the extra information acquisition section 104 acquires the extra information, the extra information display determination section 106 determines whether the extra information is to be displayed. For such determination, the extra information display determination section 106 references risk level information acquired by the risk level acquisition section 105. The risk level information may include vehicle speed information from the drive control apparatus 4, lane change information from a direction indicator (unshown), and map and traffic information from the navigation system 6.

When the extra information is to be displayed, the display time setting section 107 sets a display time, that is, the length of time for displaying the extra information. Although detailed information will be given later, the driving information display apparatus 100 according to the embodiment sets the display time when the extra information is to be displayed. This allows the extra information to be displayed during the display time whereas preventing the extra information from being displayed after the elapse of the display time. Further, when the display time is to be set, the driving information display apparatus 100 references both the extra information acquired by the extra information acquisition section 104 and the risk level information acquired by the risk level acquisition section 105, and sets the display time based on the risk level information and the extra information.

Upon receipt of the extra information acquired by the extra information acquisition section 104, the extra information output control section 108 supplies the extra information to the image output section 103 during the display time set by the display time setting section 107. Even when the value of the extra information (e.g., the distance to the following vehicle) is changed, the extra information is updated accordingly during the display time. Upon receipt of the extra information from the extra information output control section 108, the image output section 103 generates an image to be actually displayed on the screen of the display 50R, and outputs the generated image to the display 50R in addition to the driving information supplied from the driving information acquisition section 102. The “image output section 103” of the embodiment outputs the driving information and the extra information to the display 50R. Thus, a portion of the image output section 103 that outputs the driving information to the display 50R may be particularly referred to as the “driving information output section 103a”, and a portion of the image output section 103 that outputs the extra information to the display 50R may be particularly referred to as the “extra information output section 103b”.

The vehicle 1 containing the driving information display apparatus 100 according to the embodiment is able to display the extra information to the driver without incurring the risk of diverting the driver's attention away from the surroundings. The following describes a process that the driving information display apparatus 100 according to the embodiment performs to display the driving information to the driver for the purpose of implementing the above feature.

B. Driving Information Display Process

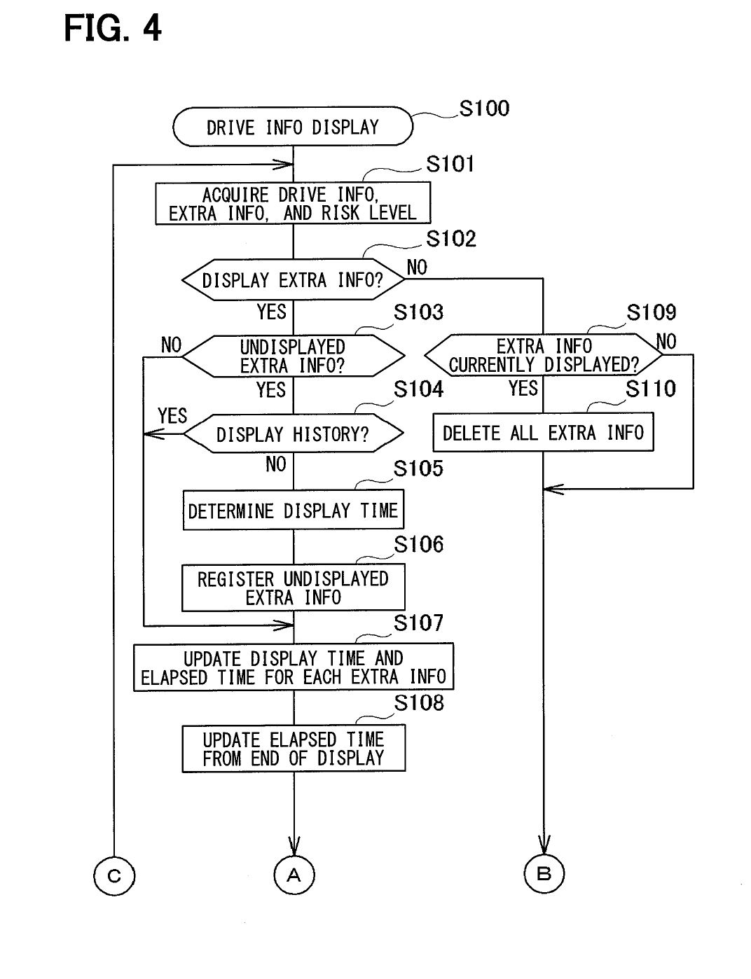

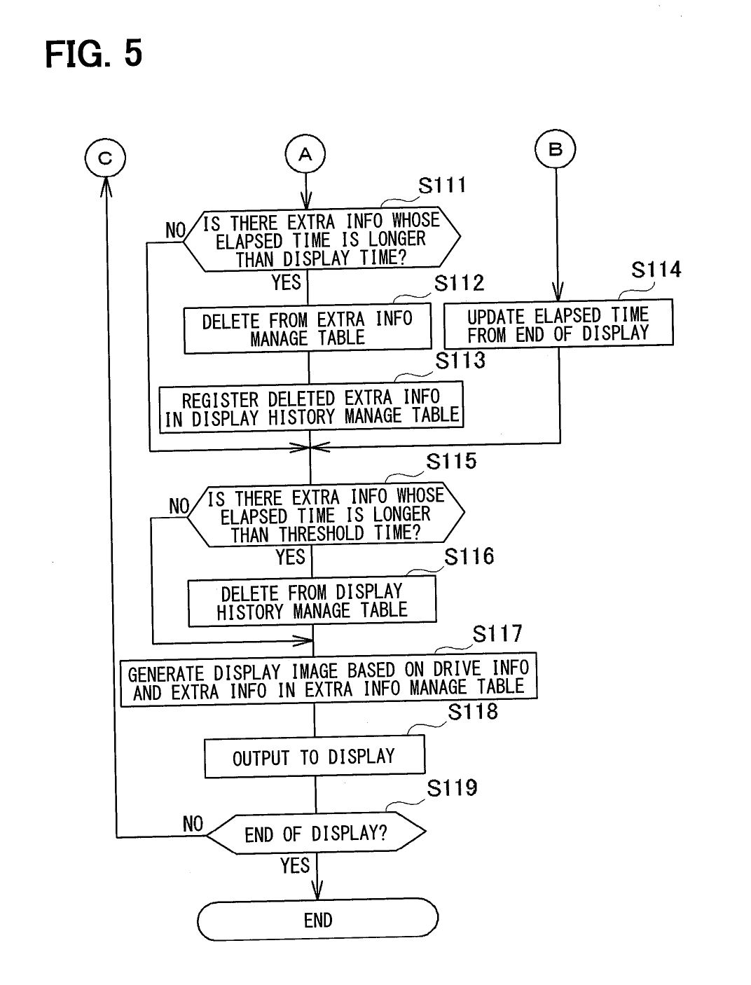

A. FIGS. 4 and 5 are flowcharts illustrating a driving information display process (or a driving information display method) that is performed by the driving information display apparatus 100 to display the driving information and the extra information on the screens of the displays 50L, 50R, 51, 52. The following assumes that the driving information display apparatus 100 is connected to the display 50R.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device or a module. Each or any combination of sections explained in the above can be achieved as (i) a software section in combination with a hardware unit (e.g., computer) or (ii) a hardware section, including or not including a function of a related apparatus; furthermore, the hardware section may be constructed inside of a microcomputer.

As illustrated, in the driving information display process (S100), the driving information, the extra information, and the risk level information are acquired (S101). As the driving information display apparatus 100 is connected to the display 50R, an image acquired by the right lateral camera 10R is acquired as the driving information. Further, the extra information detected by the image processing apparatus 5, such as the position of the following vehicle, the distance to the following vehicle, and the vehicle speed of the following vehicle, is acquired from the image captured by the right lateral camera 10R. The informations may be acquired by the image processing apparatus 5 through the analysis of the image captured by the right lateral camera 10R or detected by a different instrument (e.g., a radar (unshown) or a wireless communicator for vehicle-to-vehicle communication or road-to-vehicle communication) and outputted to the in-vehicle network 2.

Various information is acquired as the risk level information. The risk level information to be acquired includes information about the vehicle speed of the vehicle 1, information about the brightness of the surroundings of the vehicle 1, information about weather (rainy or not rainy), information indicative of a manipulated direction indicator (unshown), and information about an intersection, a road junction, and a tunnel. The risk level information may be of any kind as far as it indicates the degree of necessity of the driver confirming the surroundings of the vehicle 1. The information about the vehicle speed is outputted to the in-vehicle network 2 by the drive control apparatus 4. The information about the brightness of the surroundings and the information indicative of whether the weather is rainy are detected by a well-known daylight sensor or rain sensor and outputted to the in-vehicle network 2. The information indicative of a manipulated direction indicator is outputted to the in-vehicle network 2 by the direction indicator. The information about an intersection, a road junction, and a tunnel is outputted to the in-vehicle network 2 by the navigation system 6. Additionally, information about obstacles detected by the sonars 12L, 12R, 13L, 13R and information about pedestrian and obstacles detected from images captured by the front camera 10F and the rear camera 10B by the image processing apparatus 5 are also acquired as the risk level information. The driving information display apparatus 100 acquires the above-mentioned various information from the in-vehicle network 2 through the network connection section 101 (S101).

Whether the display 50R may display the extra information is determined (S102). When an obstacle in the vicinity of the vehicle 1 is detected by the sonar 12L, 12R, 13L, 13R, it is important that the driver visually confirm the detected obstacle. If the display 50R displays the extra information in such a situation, the driver's attention is drawn to the display 50R. Thus, the driver may visually confirm the detected obstacle with a moment's delay or fail to pay attention on the detected obstacle. The extra information should not be displayed in the above instance. Even when a pedestrian or a vehicle is detected in an image captured by the front camera 10F or the rear camera 10B, it is important that the driver visually confirm the detected pedestrian or vehicle. The extra information should not be displayed in this instance, either. Further, in the vicinity of an entry to or an exit from a tunnel, the brightness of surroundings greatly changes so that it is difficult to confirm the surroundings. Therefore, the driver should concentrate on confirming the surroundings. The extra information should not be displayed. Furthermore, when the vehicle 1 approaches an intersection, the driver needs to visually confirm the existence of traffic lights and pedestrians. The extra information should not be displayed in such an instance, either. As described, the driving information display apparatus 100 determines based on the risk level information whether the acquired extra information may be displayed (S102). This manner can avoid the display of the extra information when the extra information should not be displayed.

If it is determined that the extra information may be displayed (S102: YES), the acquired extra information is checked to determine whether any extra information is left undisplayed on the display 50R (S103). Whether there is undisplayed extra information can be determined by referencing an extra information management table. The extra information management table is stored in a memory of the driving information display apparatus 100 and used to manage the display time of extra information currently displayed on the display 50R.

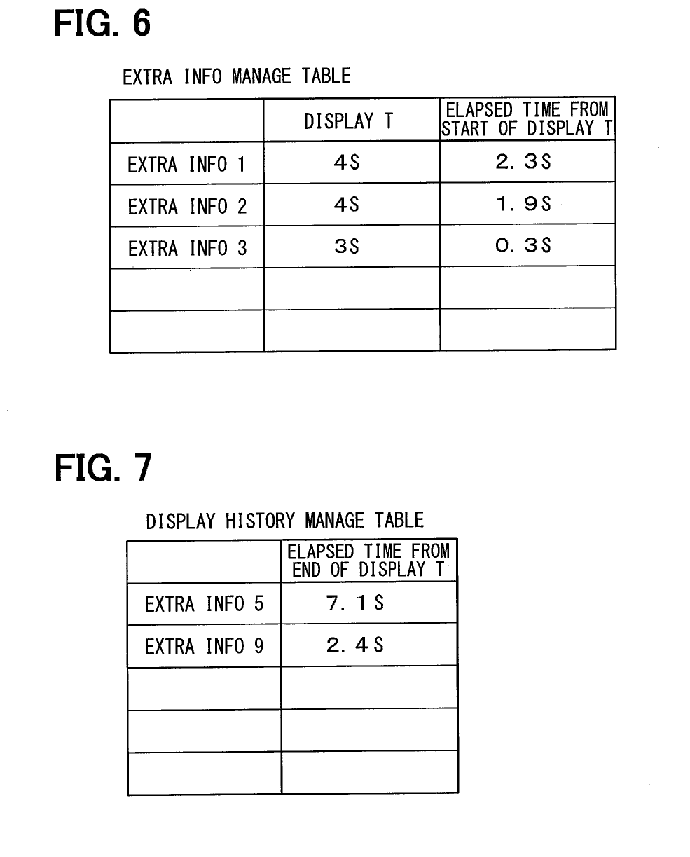

FIG. 6 illustrates the extra information management table. As illustrated, all of the extra informations currently displayed on the display 50R are registered in the extra information management table. The extra information management table stores the display time set for each item of the extra information and the elapsed time from the beginning of the display of each item of the extra information. For “EXTRA INFO 1”, a display time of 4 seconds is currently set, and the elapsed time from the beginning of display is 2.3 seconds. For “EXTRA INFO 2”, a display time of 4 seconds is set, and the elapsed time from the beginning of display is 1.9 seconds. A process of setting the display time for each item of the extra information and a process of memorizing the elapsed time from the beginning of display will be described later. As described, the extra information management table stores, for each item of the extra information, the display time for the extra information displayed on the display 50R and the elapsed time from the beginning of display. If the extra information acquired from the in-vehicle network 2 is registered in the extra information management table, it can be determined that the acquired extra information is currently displayed. By contrast, if the acquired extra information is not registered, it can be determined that the acquired extra information is still not displayed.

If undisplayed extra information exists among the acquired extra information (S103: YES), whether the undisplayed extra information is left in a display history is determined (S104). The display history indicates whether the extra information was displayed on the display 50R. Although details will be given later, the embodiment sets the display time when the extra information is to be displayed, and terminates the display of the extra information at the end of the display time. Until the lapse of a predetermined threshold time (e.g., 10 seconds) even after the display is terminated, the embodiment uses the display history to memorize that the extra display was displayed. If any undisplayed extra information is found and left in the display history, that extra information need not be urgently displayed because its display was just terminated because of the lapse of its display time. Consequently, if undisplayed extra information exists (S103: YES), whether the undisplayed extra information is left in the display history is determined (S104).

The display history of the extra information is managed by using a dedicated table named the display history management table. FIG. 7 illustrates the display history management table. As illustrated, the display history management table stores the extra information whose display was terminated, and the elapsed time from the end of the display of the extra information. For “EXTRA INFO 5”, the stored elapsed time from the end of its display is 7.1 seconds. For “EXTRA INFO 9”, the stored elapsed time from the end of its display is 2.4 seconds. If the elapsed time from the end of display exceeds a threshold time (e.g., 10 seconds), the associated extra information is deleted from the display history management table. A process of registering the extra information in the display history management table, a process of updating the elapsed time in the display history management table, and a process of deleting the extra information from the display history management table will be described later. If undisplayed extra information is not registered in the display history management table, it is determined in S104 that the undisplayed extra information is not left in the display history (S104: NO). By contrast, if undisplayed extra information is registered in the display history management table, it is determined that the undisplayed extra information is left in the display history (S104: YES).

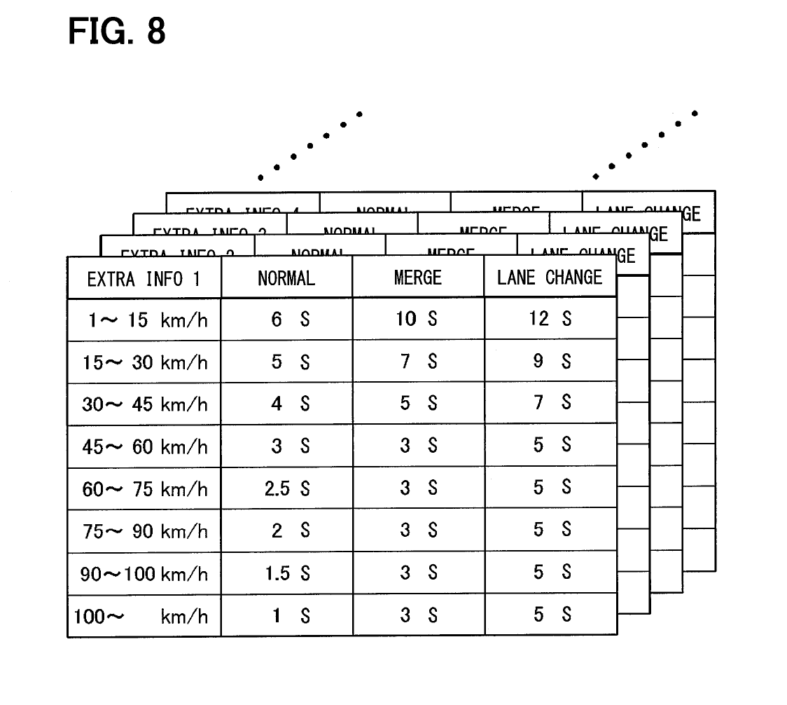

If the undisplayed extra information is not left in the display history (S104: NO), the display time for the undisplayed extra information is determined in order to display it on the display 50R (S105). The display time for the extra information is calculated by multiplying a “basic display time” by a “correction coefficient”. That is, the display time is defined to be equal to the correction coefficient multiplied by the basic display time. As in FIG. 8, the basic display time for each type of extra information is determined based on the risk level information.

For example, the basic display time for extra information 1 is determined by the vehicle speed, which is one item of the risk level information, and a travel condition (e.g., a merge into a different road, a lane change, or a normal condition) derived from the risk level information. For the “NORMAL” condition, the basic display time for extra information 1 is set to 6 seconds when the vehicle speed is 1 to 15 km/h. When the vehicle speed is 15 to 30 km/h, the basic display time is set to 5 seconds. When the vehicle speed is 30 to 45 km/h, the basic display time is set to 4 seconds. In this manner, the higher the vehicle speed, the shorter the setting for the basic display time. The reason is that when the vehicle speed becomes higher, the driver's attention should be more focused on the direction of the travel of the vehicle 1, and that the line of sight of the driver should not be directed to the extra information on the display 50R, which implements an electronic side view mirror, for an extended period of time.

The vehicle speed precisely reflects the extent to which the driver should focus on the direction of the travel of the vehicle 1. It is particularly effective that the vehicle speed is acquired as the risk level information. Further, when the extra information is displayed on the displays 50R, 50L, which implement an electronic side view mirror, the line of sight of the driver will be diverted away from the direction of the travel of the vehicle 1. When the display 50R or the display 50L is about to display the extra information, it is particularly effective that the display time is set.

Furthermore, as an electronic side view mirror is implemented by the display 50R, it is likely that the driver wants to confirm the extra information when merging into a different road or changing lanes. For a merge into a different road or a lane change, the basic display time is set to be longer than for a normal condition. Moreover, the basic display time for a lane change is set to be longer than for a merge into a different road in order to keep the extra information displayed at least until the lane change is completed.

In order to avoid a complicated description or illustration, the preceding description has been made without specifically indicating the direction (leftward of rightward) of merge or lane change. However, when making a rightward merge, the driver wants to confirm the extra information displayed on the right display 50R in the vehicle compartment. When making a leftward merge, the driver wants to confirm the extra information displayed on the left display 50L in the vehicle compartment. Similarly, when making a rightward lane change, the driver wants to confirm the extra information displayed on the right display 50R in the vehicle compartment. When making a leftward lane change, the driver wants to confirm the extra information displayed on the left display 50L in the vehicle compartment. For a rightward merge or lane change, the basic display time for the extra information to be displayed on the display 50R is set to be longer than for a normal condition, but the basic display time for the extra information to be displayed on the display 50L may be set to be the same as for a normal condition. Similarly, for a leftward merge or lane change, the basic display time for the extra information to be displayed on the display 50L is set to be longer than for a normal condition, but the basic display time for the extra information to be displayed on the display 50R may be set to be the same as for a normal condition.

The risk level information to be considered when the basic display time is to be determined varies with the type of extra information. In FIG. 8, the basic display time for the risk level information to be considered is set and stored in tabular form for each type of extra information. When the display time for the extra information is to be determined, the basic display time is acquired by referencing a table associated with that extra information.

Meanwhile, the correction coefficient is used to uniformly increase the basic display time determined based on the risk level information when it is difficult for the driver to conform the surroundings, for example, at nighttime or in a rainy weather. In the embodiment, the correction coefficient is set to 2 for nighttime, 1.5 for a rainy weather, and 1 for a normal condition except nighttime and rainy weather. Information indicative of nighttime or rainy weather is also acquired from the in-vehicle network 2 as the risk level information. In the embodiment, the display time is determined by correcting the basic display time set based on the risk level information with the correction coefficient determined based on the risk level information.

After the display time for the undisplayed extra information is determined as described, the extra information and the determined display time are registered in the extra information management table (S106 in FIG. 4). The extra information registered in the extra information management table in FIG. 6 is registered in the above manner. For the extra information management table, the maximum permissible number of registerable extra informations may be predefined. Up to five extra informations can be registered in the extra information management table in FIG. 6. Even when there arises extra information to be newly registered, such new extra information need not be registered in the extra information management table if the number of extra informations already registered in the extra information management table has reached the maximum permissible number. Although details will be given later, the extra information to be displayed on the display 50R is determined based on the extra information management table. When the maximum permissible number of registerable extra informations is predefined, it is possible to avoid a situation where a large number of extra informations are displayed to excessively draw the driver's attention or make the displayed extra information illegible. Alternatively, if the number of registered extra informations has reached the maximum permissible number when there arises extra information to be newly registered, registered extra information displayed for the longest period of time may be deleted to register the new extra information. Thus, extra information that is highly likely to have been confirmed by the driver can be deleted to display extra information that is still not confirmed by the driver. Consequently, the extra information can be efficiently displayed to the driver while suppressing the number of extra informations to be displayed.

In the above description, the display time for undisplayed extra information is determined to perform a process of registering the undisplayed extra information in the extra information management table (S105 and S106) when the undisplayed extra information exists in the extra information acquired from the in-vehicle network 2 (S103: YES) and not left in the display history (S104: NO). Meanwhile, the above description does not deal with a process that is performed to determine the display time (S105) and register extra information in the extra information management table (S106) when no undisplayed extra information exists (S103: NO) or existing undisplayed extra information (S103: YES) is left in the display history (S104: YES).

The driving information display apparatus 100 according to the embodiment updates, for each extra information registered in the extra information management table, the display time and the elapsed time from the beginning of display (S107). Updating the elapsed time from the beginning of display will be first described. As described, the display time for the extra information is set when it is to be displayed on the display 50R. After the beginning of display, a timer (unshown) built in the driving information display apparatus 100 measures, for each extra information, the elapsed time from the beginning of display so as to update the elapsed time in the extra information management table. Although the display time is determined when the extra information is to be displayed, the value of the display time depends on the risk level information as mentioned. The risk level information changes from moment to moment even after the beginning of extra information display. Therefore, even if the display time is appropriate at the beginning of display, the appropriate value of the display time may change based on subsequent situation changes. Thus, the display time is periodically updated to an appropriate value even after the display time is set with the extra information registered in the extra information management table.

As is the case with display time determination for undisplayed extra information, the value to which the display time is to be updated is calculated by multiplying the basic display time determined based on current risk level information by the correction coefficient. The display time set in the extra information management table is then updated to the newly obtained display time. Further, the elapsed time from the end of display is also updated for the extra information registered in the display history management table in FIG. 7 (S108).

The extra information registered in the extra information management table is checked to determine whether there is extra information whose elapsed time from the beginning of display has exceeded the display time (S111 in FIG. 5). The extra information management table to be referenced in this instance is such that the display time and elapsed time for the registered extra information are updated (S107 in FIG. 4). Thus, if there is extra information whose elapsed time from the beginning of display is longer than the updated display time (S111: YES), the extra information is deleted from the extra information management table (S112), and then the deleted extra information is registered in the display history management table (S113). The extra information registered in the display history management table in FIG. 7 is registered in the above-described manner. By contrast, if there is no extra information whose elapsed time from the beginning of display is longer than the display time (S111: NO), the process of deleting the extra information from the extra information management table (S112) and registering the deleted extra information in the display history management table (S113) is not performed.

The above-described process is performed when it is determined (S102: YES) that the extra information may be displayed on the display (the display 50R in the current example) after the driving information, the extra information, and the risk level information are acquired from the in-vehicle network 2 (S101 in FIG. 4). Meanwhile, when it is determined that the extra information should not be displayed on the display 50R (S102: NO), the following processing performed.

First of all, whether currently displayed extra information (i.e., extra information registered in the extra information management table) exists is determined (S109). If it is determined that currently displayed extra information exists (S109: YES), all of extra informations registered in the extra information management table are deleted (S110). By contrast, if no currently displayed extra information exists (S109: NO), the process of deleting the extra information registered in the extra information management table (S110) is skipped.

For the extra information registered in the display history management table, the elapsed time from the end of display is updated (S114 in FIG. 5). In this instance, the extra information deleted from the extra information management table is not registered in the display history management table. If it is determined that the extra information should not be displayed (S102 in FIG. 4: NO), the elapsed time for the extra information registered in the display history management table is simply updated without registering, in the display history management table, the extra information deleted from the extra information management table.

After the above-described sequence (S102-S114) is performed on the extra information management table and the display history management table, the extra information registered in the display history management table is checked (S115) to determine whether there is extra information whose elapsed time from the end of display is longer than a predetermined threshold time (e.g., 10 seconds). If it is determined that there is extra information whose elapsed time is longer than the threshold time (S115: YES), the extra information is deleted from the display history management table (S116). When deleted from the display history management table, the extra information is deleted from the display history.

By contrast, if there is no extra information whose elapsed time from the end of display is longer than the threshold time (S115: NO), the process of deleting the extra information from the display history management table (S116) is skipped. The extra information left registered in the display history management table remains in the display history. While the extra information is left in the display history, the query in S104 of FIG. 4 is answered “YES” even if new extra information is acquired, and the extra information left in the display history is not registered in the extra information management table. Therefore, the extra information left in the display history is kept from being displayed on the display 50R.

Upon completion of the above-described process (S115 and S116) performed on the display history management table, a display image to be displayed on the display 50R is generated (S117) based on the driving information acquired in S101 of FIG. 4 and the extra information registered in the extra information management table. The display image generated in the example illustrated at (c) in FIG. 2 includes an image (driving information) captured by the right lateral camera 10R, a highlighted outline indicative of the position of the following vehicle, the speed of the following vehicle, the distance to the following vehicle, and a message indicative of the inability to change lanes. Numerical values (e.g., the speed of and the distance to the following vehicle) displayed in this instance as the extra information are newly acquired in S101.

It is determined whether the display operation of the display 50R is to be terminated (S119). If the display operation is not to be terminated (S119: NO), processing returns to the beginning of the process so that the above-described sequence is repeated after acquiring new driving information, extra information, and risk level information (S101 in FIG. 4). By contrast, if the display operation of the display 50R is to be terminated (S119 in FIG. 5: YES), the driving information display process in FIGS. 4 and 5 terminates.

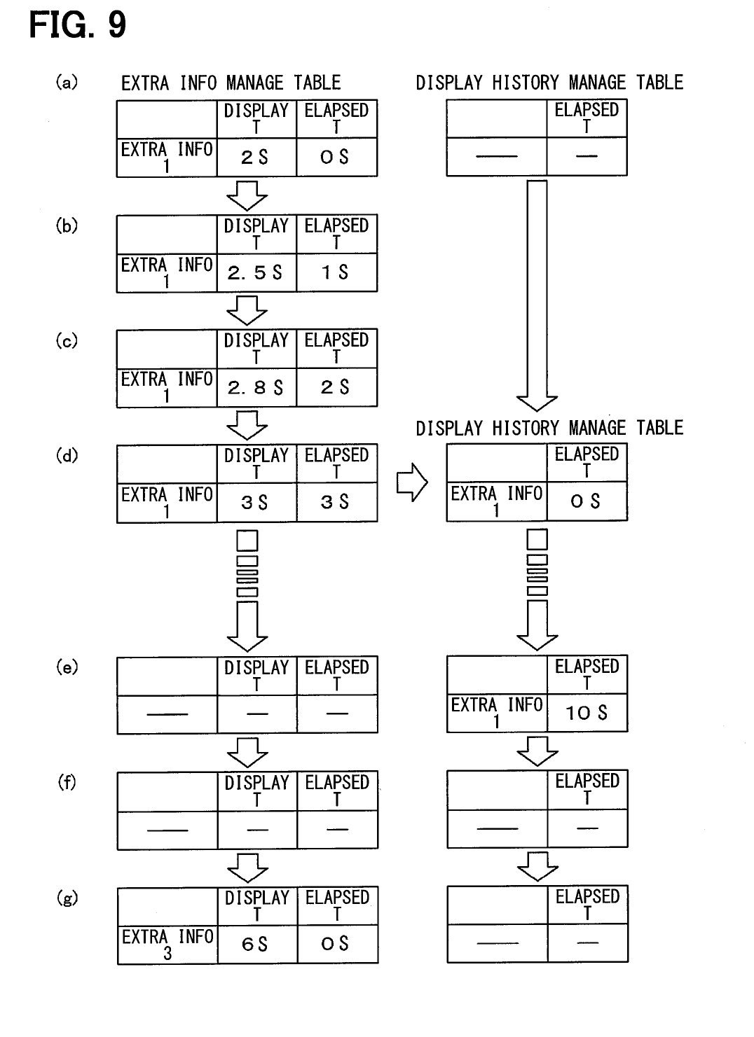

FIG. 9 illustrates how the driving information display apparatus 100 according to the embodiment manages the display of the extra information by using the extra information management table and the display history management table. Assume that undisplayed extra information (extra information 1) is acquired to determine its display time and registered in the extra information management table. A state where extra information 1 has just been registered in the extra information management table in the above manner (this state corresponds to S106 in FIG. 4) is illustrated at (a) in FIG. 9. After extra information 1 is registered in the extra information management table in the above manner, the elapsed time from the beginning of display is updated (S107 in FIG. 4) as mentioned earlier with reference to FIGS. 4 and 5 each time the driving information display process is performed. Further, the display time is also updated based on subsequent changes in the risk level information (S107).

At 1 second after the beginning of display, the display time is increased from 2 seconds (2 s) to 2.5 seconds (2.5 s) due to a decrease in the vehicle speed at (b) in FIG. 9. At 2 seconds after the beginning of display, the display time is increased to 2.8 seconds at (c) in FIG. 9. Then, at 3 seconds after the beginning of display, the elapsed time reaches the display time at (d) in FIG. 9. Thus, extra information 1 is deleted from the extra information management table (S112 in FIG. 5). Instead, extra information 1 is registered in the display history management table (S113). The elapsed time (the elapsed time from the end of display) for extra information 1 is successively updated. When the elapsed time reaches a threshold time (10 seconds in the current example) at (e) in FIG. 9, extra information 1 is deleted from the display history management table.

When the extra information (extra information 1 in the current example) is registered in the extra information management table as described, the extra information remains registered until the elapsed time from the beginning of display reaches the display time. During such a period, extra information 1 is displayed on the display 50R. The display time is successively updated even after the extra information is registered in the extra information management table (i.e., after the beginning of extra information display). Even if driving conditions are changed after the beginning of extra information display, the extra information can be flexibly displayed for an appropriate period of time based on changes in the driving conditions. When the display time elapses, the display of the extra information terminates. The driver's attention can be naturally directed to the surroundings of the vehicle 1.

After the extra information (extra information 1 in the current example) is displayed for the display time, the extra information is registered in the display history management table and will not be deleted from the display history management table until a predetermined threshold time elapses. This can avoid a situation where the extra information becomes redisplayed immediately after the termination of its display to let displayed unnecessary extra information excessively draw the driver's attention.

The preceding description assumes that the display for displaying the driving information and the extra information is the display 50R that implements an electronic side view mirror. However, the present invention is applicable to any display capable of displaying the driving information and the extra information.

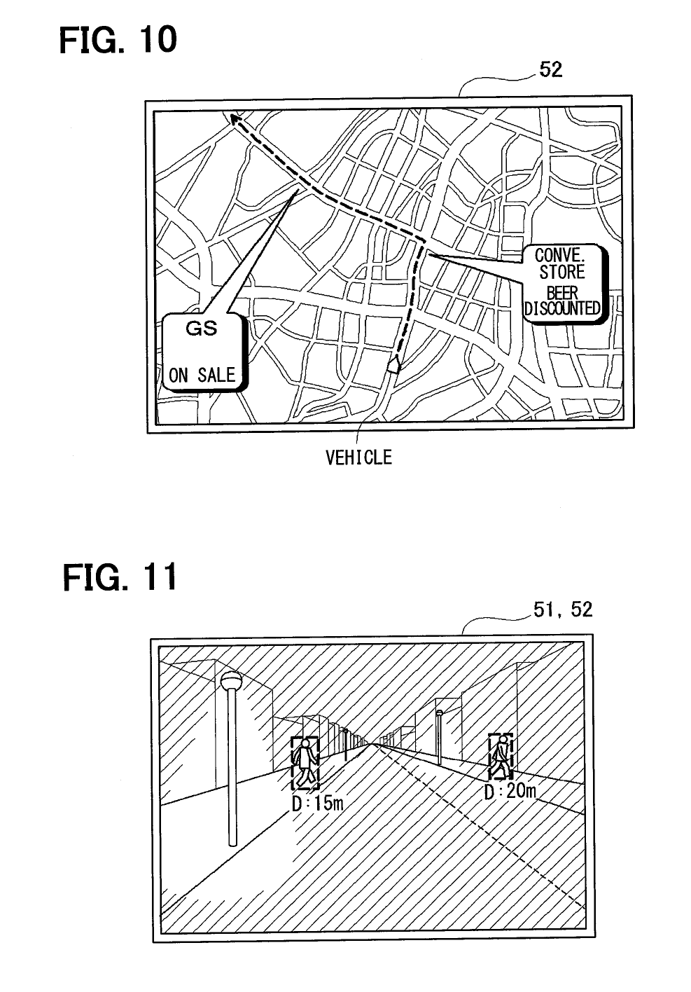

The display 52 connected to the navigation system 6 displays map information about an area around the vehicle 1 and driving information indicative, e.g., of a route to a destination. A wireless communication instrument (unshown) may display information derived from so-called road-to-vehicle communication and information stored in the navigation system 6 as the extra information. FIG. 10 illustrates how information about stores located along a route is displayed as the extra information. When setup is performed so as to terminate the display of such extra information at the end of display time based on the risk level information, the driver's attention can be directed to the surroundings of the vehicle 1 at the end of extra information display. As the extra information does not remain displayed for an extended period of time, the driver's attention will not be excessively drawn to the extra information.

The display 51 disposed behind the steering wheel 3 and the display 52 disposed at the center of the dashboard may display an image captured by the front camera 10F as the driving information. When the image processing apparatus 5 detects, pedestrians in the captured image, a highlighted outline indicative of the existence of a pedestrian and the distance to the pedestrian may be displayed as the extra information. FIG. 11 illustrates a situation where the highlighted outline (indicated by a broken-line rectangle in FIG. 11) and the distance to a pedestrian are displayed as the extra information about the pedestrian detected in the image captured by the front camera 10F.

Meanwhile, the display 51 disposed behind the steering wheel 3 displays the remaining fuel amount as the driving information. When the remaining fuel amount is small, the display 51 may display the estimated distance to empty as the extra information. FIG. 12 illustrates a situation where the estimated distance to empty, which is outputted from the drive control apparatus 4, is displayed as the extra information above an image indicative of the remaining fuel amount (or above a fuel gauge). When this type of extra information is also displayed with the display time set based on the risk level information, the driver's attention can be directed to the surroundings of the vehicle 1 at the end of display. Additionally, the display of such extra information does not excessively draw the driver's attention.

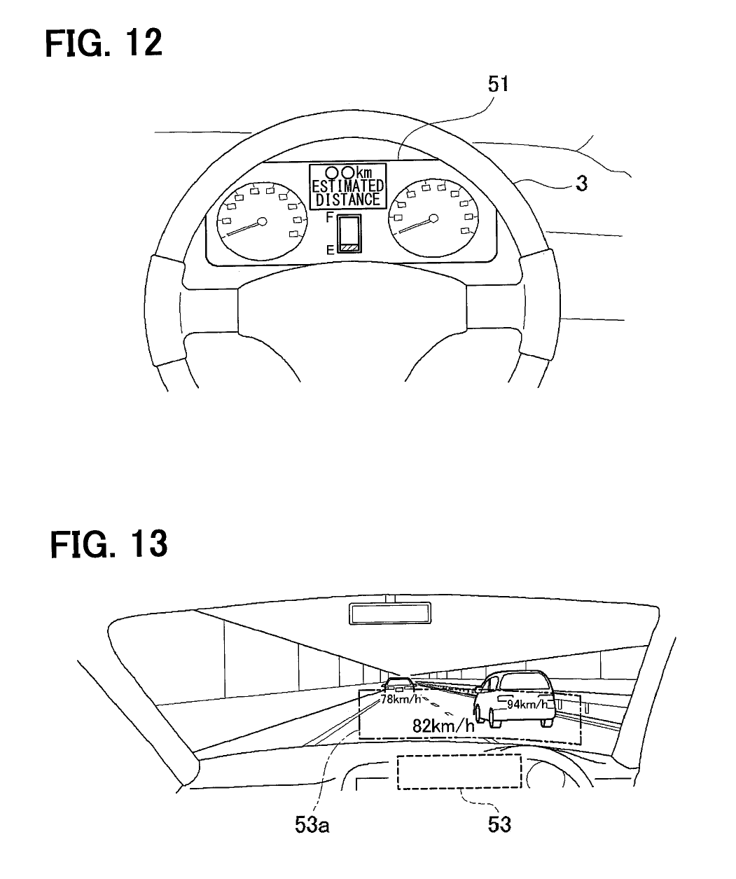

There is developed and available a head-up display apparatus, which projects an image onto a transparent plate member (e.g., a windshield or a combiner) disposed in front of a driver's seat and allows the driver to visually recognize a virtual image. The head-up display apparatus may also display various extra information in addition to the driving information such as the vehicle speed of the vehicle 1 (host vehicle). In FIG. 13, the head-up display apparatus 7 built in the dashboard displays a large virtual image indicative of the vehicle speed of the vehicle 1 (82 km/h in the example) in a display area 53 of the windshield. In addition, small images indicative of the vehicle speeds of preceding vehicles are displayed as the extra information over the preceding vehicles. In this instance, too, when the extra information is displayed with the display time set based on the risk level information, the driver's attention can be directed to the direction of the travel of the vehicle 1 at the end of display. Further, the display of such extra information does not excessively draw the driver's attention. In FIG. 13, the display area 53 of the head-up display apparatus 7 is referred to also as a display.

In the above embodiment, when the driving information display apparatus 100 acquires the extra information from the in-vehicle network 2, it is determined whether the extra information may be displayed on the display 50R, 50L, 51, 52 connected to the driving information display apparatus 100 (see S102 in FIG. 4). If it is determined based on the current risk level information that the extra information should not be displayed, the acquired extra information is not to be displayed. However, whether the acquired extra information is to be displayed may be determined based on the acquired extra information.

At (a) in FIG. 2, an image captured by the right lateral camera 10R includes a small image of a following vehicle. However, as the image processing apparatus 5 is unable to detect the following vehicle in the captured image, a highlighted outline (extra information) is not displayed. Meanwhile, at (b) in FIG. 2, the highlighted outline (extra information) is displayed because the image processing apparatus 5 is able to detect the following vehicle in the captured image. As described, whether the extra information (the highlighted outline in this case) is to be displayed depends on whether the extra information flows in the in-vehicle network 2 (depends, in this case, whether the following vehicle is detected by the image processing apparatus 5). However, whether the extra information is to be displayed may be individually determined depending on the contents of the extra information after the driving information display apparatus 100 acquires the extra information from the in-vehicle network 2. At (b) in FIG. 2, even when the highlighted outline for the following vehicle is acquired, the highlighted outline may be left undisplayed if it is small in size. In this manner, whether the extra information is to be displayed can be more appropriately determined based on the display 50L, 50R, 51, 52 connected to the driving information display apparatus 100.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

What is claimed is:

1. A driving information display apparatus in a vehicle containing a display positioned to be viewable by a driver of the vehicle, the driving information display apparatus causing the display to display driving information to the driver along with driving of the vehicle, the driving information display apparatus comprising:
a driving information acquisition section that acquires the driving information;
a driving information output section that outputs the acquired driving information to the display;
an extra information acquisition section that acquires predefined extra information, the extra information being displayed in addition to the driving information;
an extra information output section that outputs the extra information to the display;
a risk level information acquisition section that acquires risk level information about a level of risk involved in the driving of the vehicle;
a display time setting section that sets a display time of displaying the extra information based on the risk level information, when the extra information is acquired; and
an extra information output control section that controls outputting of the extra information based on the set display time,
wherein:
the risk level information acquisition section acquires, as the risk level information, subject information that is about an existence of at least either (i) a merge of the vehicle into a different road or (ii) a lane change of the vehicle; and
the display time setting section sets the display time when the subject information about the existence is acquired to be a longer than the display time when the subject information is not acquired.

2. The driving information display apparatus according to claim 1, further comprising:
an extra information display determination section that, when the extra information is acquired, determines whether to cause the display to display the extra information, based on the risk level information.

3. The driving information display apparatus according to claim 2,
wherein the extra information display determination section is a determination section that determines whether to cause the display to display the extra information, based on the extra information as well.

4. The driving information display apparatus according to claim 2,
wherein the extra information display determination section is a determination section that determines either an execution or an non-execution of displaying the extra information, to ensure that a displayed number of the extra informations that are to be displayed on the display is equal to or less than a predetermined maximum permissible number.

5. The driving information display apparatus according to claim 2,
wherein the extra information display determination section is
an determination section that,
when terminating displaying of the extra information because of a lapse of the display time of displaying the extra information,
determines preventing the display from displaying the extra information until a predetermined threshold time elapses.

6. The driving information display apparatus according to claim 1,
wherein the risk level information acquisition section acquires a vehicle speed of the vehicle as the risk level information.

7. The driving information display apparatus according to claim 1,
wherein the display is an electronic side view mirror.

8. A driving information display method applied to a vehicle containing a display positioned to be viewable by a driver of the vehicle, the driving information display method causing the display to display driving information to the driver along with driving of the vehicle, the driving information display method comprising:
acquiring the driving information;
outputting the acquired driving information to the display;
acquiring predefined extra information, the extra information being displayed in addition to the driving information;
outputting the extra information to the display;
acquiring risk level information about a level of risk involved in the driving of the vehicle;
setting a display time of displaying the extra information based on the risk level information, when the extra information is acquired; and
controlling outputting of the extra information based on the set display time,
wherein:
as the risk level information, subject information is acquired which is about an existence of at least either (i) a merge of the vehicle into a different road or (ii) a lane change of the vehicle; and
the display time when the subject information about the existence is acquired is set to be a longer than the display time when the subject information is not acquired.

9. The driving information display apparatus according to claim 1,
wherein:
the risk level information acquisition section acquires, as the risk level information, the subject information including first information about an existence of a merge of the vehicle into a different road and second information about an existence of a lane change of the vehicle; and
the display time setting section sets the display time of displaying the extra information when the first information about an existence of a lane change of the vehicle is acquired to be longer than the display time when the second information about a merge of the vehicle into a different road is acquired.

10. The driving information display apparatus according to claim 6,
wherein the display time setting section sets the display time of displaying the extra information to be shorter as the vehicle speed acquired as the risk level information becomes greater.
